(19) United States
(12) Patent Application Publication
(10) Pub. No.: US 2011/0192046 A1
(43) Pub. Date: Aug. 11, 2011

(54) GAME FISH MEASURING DEVICE AND METHODS

(76) Inventor: Michael Patrick Kinziger, Pound, WI (US)

(21) Appl. No.: 13/022,155

(22) Filed: Feb. 7, 2011

Related U.S. Application Data
(60) Provisional application No. 61/302,449, filed on Feb. 8, 2010.
(60) Provisional application No. 61/330,469, filed on May 3, 2010.

(51) Int. Cl. G01B 3/10

(52) U.S. Cl. 33/759; 33/701

(57) ABSTRACT

A fish measuring device preferably substantially contains or surrounds a fish, and thus calms the fish, and provides a relatively quick measurement of the fish's length. An elongate tube preferably contains a capped end with a visual inspection portion proximate the capped end. A cut out distal from the capped end preferably includes a primary length indicator. When a fish is measured, the user places the fish in the tube, preferably under water, with the tube partially filled with water, or with the tube previously wetted. The user visually confirms the nose of the fish touches the capped end and reaches through the cut out distal from the capped end to squeeze the tail fins of the fish together. The user compares the position of the squeezed tail fins against the primary length indicator, preferably to determine whether the fish is shorter than, or at least meets, a legal length limit.

### RELATED APPLICATIONS

This application claims priority under 35 U.S.C. §119(e) to U.S. Provisional Application No. 61/302,449 titled “The device is made of a plastic tube that allows fishermen to accurately measure fish between seven and 24 inches while reducing the amount of stress on the fish,” filed on Feb. 8, 2010 and to U.S. Provisional Application No. 61/330,469 titled “Game Fish Measuring Devices And Methods,” filed on May 3, 2010, both of which are fully incorporated herein by reference.

### TECHNICAL FIELD

The present disclosure relates to devices and methods for measuring game fish.

### BACKGROUND

Many jurisdictions require fish of a certain species to be a minimum length to be kept, otherwise the fish must be returned to the water unharmed. Such minimum length regulations are particularly common for fresh water game fish such as walleye, northern pike, muskellunge, trout, bass, perch, and etc. Sport fishers therefore commonly need to measure the length of a caught fish to know whether the fish may be kept or must be returned to the water.

Common devices for measuring the length of a caught fish include using a cloth, metallic, or plastic measuring tape, using a stick or other rigid elongate object, sometimes foldable, having distance measuring marks, or placing a fish in an elongate U-shaped half tube having a cap at one end and distance measuring marks inside the U-shaped portion extending away from the cap.

### SUMMARY

The present inventor has recognized several disadvantages with current devices and methods for measuring the length of a caught fish. One such disadvantage is that many common devices and methods for using such devices, for example, tape measures and elongate measures, require removing a caught fish from the water to determine its length. Removing fish from water is stressful for the fish and risks damaging the mucus outer layer secreted through skin glands, especially if a fish is touched with a dry hand. If a fish's mucus outer layer becomes damaged, the fish becomes susceptible to fungal attacks and other diseases that may cause mortality. Another such disadvantage is that current fish measuring devices and methods typically do not contain, or surround, a fish in a manner that calms the fish. For example, an elongate U-shaped half tube having a cap at one end may be used in the water so a fish does not need to be removed from the water, but the fish is in an exposed condition and may struggle, thus making the measurement more difficult and time consuming and potentially exposing the fish to damaging itself by scraping away portions of the mucus layer, lacerations, or contusions. Another such disadvantage is that commonly available fish measuring devices may not be quick to use, thus exposing a fish to additional, unnecessary stress and handling. For a fish returned to the water, all of the foregoing increase the risk of mortality.

An exemplary embodiment provides a fish measuring device that preferably substantially contains or surrounds a fish, and thus calms the fish, and provides a relatively quick measurement of the fish's length. An elongate tube preferably contains a capped end with a visual inspection portion proximate the capped end. A cut out distal from the capped end preferably includes a primary length indicator. When a fish is measured, the user places the fish in the tube, preferably under water, with the tube partially filled with water, or with the tube having been previously wetted. The user visually confirms the nose of the fish touches the capped end and reaches through the cut out distal from the capped end to squeeze the tail fins of the fish together. The user compares the position of the squeezed tail fins against the primary length indicator, preferably to determine whether the fish is shorter than, or at least meets, a legal length limit. Preferably, using the fish measuring device does not require assistance from a second person, but may be efficiently used by a single person.

Additional aspects and advantages will be apparent from the following detailed description of preferred embodiments, which proceeds with reference to the accompanying drawings.

### BRIEF DESCRIPTION OF THE DRAWINGS

FIG. 1 illustrates rear view of a fish measuring tube according to an embodiment.

FIG. 2 illustrates a left side view of the fish measuring tube of FIG. 1.

FIG. 3 illustrates a front view of the fish measuring tube of FIG. 1.

FIG. 4 illustrates a left side view of an end cap according to an embodiment.

FIG. 5 illustrates a top view of the fish measuring tube of FIG. 1.

FIG. 6 illustrates a top view of the end cap of FIG. 4.

FIG. 7 illustrates a flow chart for a method for measuring a fish.

FIG. 8 illustrates a right-side top isometric view of a fish measuring tube according to another embodiment with a sliding tray in a stowed position.

FIG. 9 illustrates a right-side top isometric view of the fish measuring tube of FIG. 8 with the sliding tray in an unfastened position.

FIG. 10 illustrates a right-side top isometric view of the fish measuring tube of FIG. 8 with the sliding tray in a measuring position.

FIG. 11 illustrates a top plan view of the fish measuring tube of FIG. 8 with the sliding tray in a stowed position.

FIG. 12 illustrates a top plan view of the fish measuring tube of FIG. 8 with the sliding tray in a measuring position.

FIG. 13 illustrates a right-side plan view of the fish measuring tube of FIG. 8 with the sliding tray in a stowed position.

FIG. 14 illustrates a right-side plan view of the fish measuring tube of FIG. 8 with the sliding tray in a measuring position.

### DETAILED DESCRIPTION OF PREFERRED EMBODIMENTS

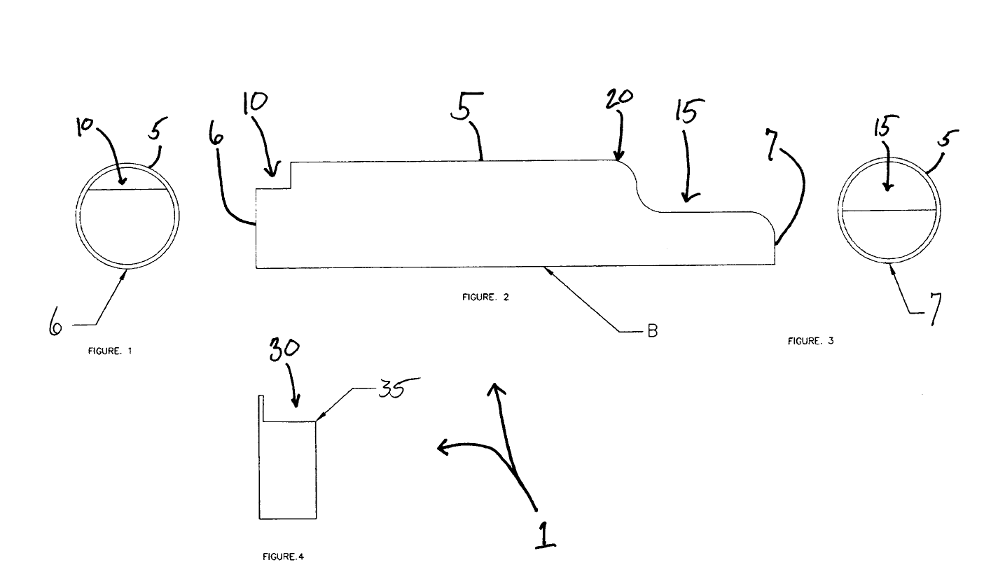

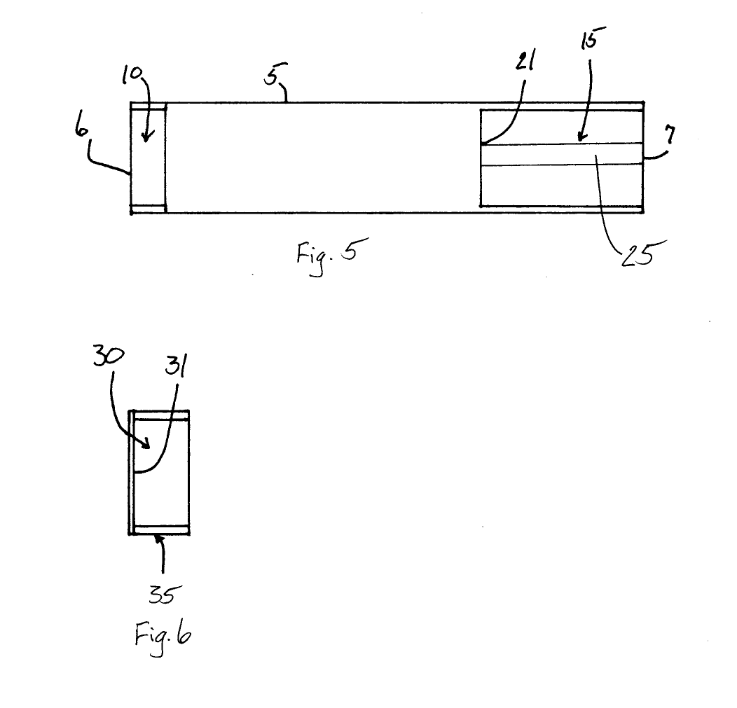

An example embodiment of a fish measuring device 1 is illustrated in FIGS. 1-6. A main tube 5 includes a viewing portion 10 at a first end 6 and a cut out portion 15 at the second end 7. In the embodiment illustrated in FIGS. 1-6, the main tube 5 is circular in cross section, but in alternate embodiments the cross section may include other shapes such as square, rectangular, triangular, or other suitable shape. In a preferred embodiment, main tube 5 is made from an opaque material, such as aluminum or polyvinyl chloride (“PVC”) pipe. Alternately, main tube 5 may be made from transparent or translucent materials, for example, Lucite®, clear, or substantially clear, plastic, glass, or other suitable material. Main tube 5 may be made by cutting or otherwise suitably modifying a length of tubing, or may be molded, machined, or made by another suitable method.

In a preferred embodiment, the viewing portion 10 is made by cutting out a section of main tube 5 to create a viewing aperture. Alternately, viewing portion 10 may be made by cutting out a portion of main tube 5 and including a transparent cover, by making a portion of main tube 5 from a transparent material, or other suitable manner. In embodiments where main tube 5 is made from a transparent or translucent material, a separate viewing portion 10 may not be needed.

Cut out portion 15 is preferably made by cutting a section of pipe to the desired profile. For example, in the embodiment illustrated in FIGS. 1-6 cut out portion 15 is made by making an S-shaped cut. The particular shape of the cut used to make cut out portion 15 may vary in alternate embodiments, for example, by making a straight cut running at an angle to an axis of main tube 5. One preferred purpose for making a cut out portion 15 is to provide access to a fish's tail when a fish is placed in the fish measuring device 1 as described in greater detail below. Another preferred purpose for making a cut out portion 15 is to provide a primary length indicator 20. Preferably, cut out portion 15 does not extend the length of main tube 5, thus leaving a closed tubular section that encloses, contains, or surrounds a fish which preferably imparts a calming effect to a fish when the fish is placed in the fish measuring device 1.

In the embodiment illustrated in FIGS. 1-6, primary length indicator 20 is preferably made as a result of cutting out cut out portion 15. For example, primary length indicator 20 may be the edge 21 formed as part of cut out portion 15. Alternately, primary length indicator may include a line drawn or inscribed on an inner surface of main tube 5. An optional secondary length indicator 25 may be included. Preferably, secondary length indicator 25 includes a set of markings that provide length information for lengths greater than the length indicated by the primary length indicator 20. Preferably, secondary length indicator 25 includes a set of measuring lines inscribed inside the main tube 5, where the starting numeral for the secondary length indicator is the numeral indicated by the primary length indicator 20. For example, if the primary length indicator 20 indicates a length of 8 inches (measured from an end wall 31 of a cap 30) then a secondary length indicator 25 preferably starts at 8 inches and includes markings for determining lengths greater than 8 inches. Fish measuring devices, such as fish measuring device 1, are not limited to having any specific primary length indicator or to having an overall length, but may include any primary length indicator and overall length.

Cap 30 preferably includes a viewing portion 35. Viewing portion 35 may be made in a similar manner to viewing portion 10. Alternately, cap 30 may be made from a transparent or translucent material, wholly or in part, and may not need a separate viewing portion 35. Cap 30 is preferably securely attached to the first end 6 of main tube 5 so that viewing portions 10 and 35 are aligned. For example, when main tube 5 and cap 30 are both made from PVC, a PVC glue may be used to secure them together. Mechanical fasteners, other glues, threads, or other suitable attachments may be used. In alternate embodiments, main tube 5 and cap 30 may be integrally formed together, for example through a molding, machining, or rapid prototyping process.

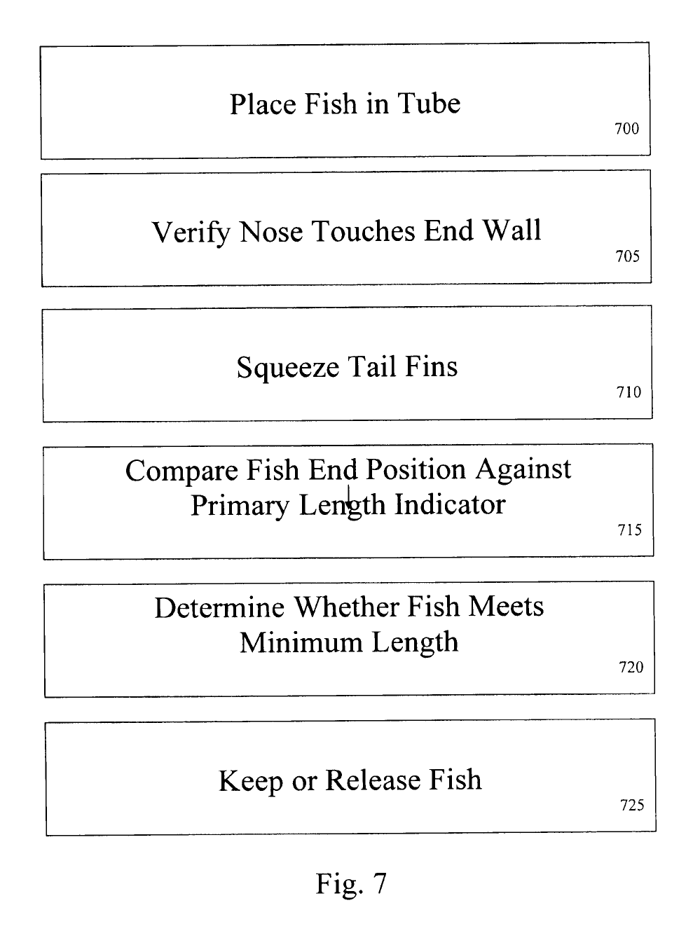

With reference to FIG. 7, after catching a fish the fish is placed nose first into main tube 5 so that the fish's nose touches an end wall 31 of cap 30 at step 700. At step 705, a visual verification is made that the fish's nose is touching end wall 31 of cap 30. The fins of the fish's tail are squeezed together at step 710 to obtain a fish end position indicative of the length of the fish. At step 715, the fish end position is compared to the position of primary length indicator 20. At step 720, whether the fish meets a minimum length is determined by observing whether the fish end position is between the primary length indicator 20 and the cap 30, or whether the fish end position touches the primary length indicator 20 or falls between the primary length indicator 20 and the second end 7 of the main tube 5. In other embodiments, whether a fish meets a minimum length is determined by comparing the fish end position against one or several markings, such as indications of centimeters or inches, of a primary length indicator or a secondary length indicator. At step 725 a fisher determines whether the fish may be kept or must be released based on the minimum length determination of step 720.

An exemplary measurement is now described. In the state of Wisconsin, a walleye must be 8 inches or longer to be kept. Any walleye shorter than 8 inches must be returned unharmed to the water. The proper manner for determining a fish's length is to measure from the tip of the nose to the tip of the tail fins when they are squeezed together. A preferred fish measuring device 1 embodiment includes a cut out portion 15 with a primary length indicator 20 that is located 8 inches from end wall 31 of cap 30. When a fisher catches a walleye and puts the walleye nose first into main tube 5, preferably with main tube 5 submerged in water, partially filled with water, or previously wetted, if the walleye disappears past the primary length indicator 20 the fisher quickly knows the fish is too short to keep and may return the fish to the water without any further handling. Otherwise, the fisher accesses the fish's tail through cut out portion 15 to squeeze the tail fins together. If the tail fins extend to or past primary length indicator 20 the fisher quickly knows the fish may be kept. Otherwise, if the squeezed tail fins do not extend past primary length indicator 20 the fisher quickly knows the fish is too short to keep. Alternately, a secondary length indicator 25 may be included. Secondary length indicator 25 may be used to determine whether a fish is a certain length longer than the legal limit, for example, if the fisher has a personal preference not to keep walleye under 12 inches.

Alternately, primary length indicator 20 may be positioned to indicate a minimum legal length for a species of game fish having a relatively short minimum length, and a secondary length indicator 25 may be included. Preferably, secondary length indicator 25 includes highlighted lines for the minimum length for various game fish species. Such an arrangement allows a fish measuring device to be quickly used for a plurality of fish species. Preferably, cut out portion 15 includes a slot running along an axis of main tube 5 to permit access to the tail of various game fish species.

In an alternate embodiment, when main tube 5 is made from a transparent or translucent material, primary length indicator 20 may include markings starting proximate cap 30 and continuing to the second end 7 of main tube 5. Certain markings may be highlighted, for example by being in a bolder line, to indicate minimum lengths for a variety of fish species. Preferably, cut out portion 15 includes a slot running along an axis of main tube 5 to permit access to the tail of various game fish species.

In alternate embodiments, a fish measuring device, such as fish measuring device 1, may include attachments such as brackets, straps, hook and loop fasteners, quick connect devices, or other suitable structure for attaching main tube 5 to another object. Use of such attachments preferably allows a fish measuring device to be used as a rod or net holder when attached to a fixed object, such as the rail of a boat. Alternatively, a stake may be attached to main tube 5 to support a fish measuring device when the stake is inserted in the ground, thus permitting a fish measuring device to act as a rod or net holder independent of being attached to a fixed structure. In other alternative embodiments, a float may be included as part of, or attached to, a fish measuring device. Preferably, such a float provides sufficient buoyancy to prevent a fish measuring device from sinking when immersed in water.

FIGS. 8-14 illustrate another example embodiment of a fish measuring device 80 where an optional handle 85 and an optional tray 90 are included. Similar to the fish measuring device 1 (FIGS. 1-6), the fish measuring device 80 includes a main tube 95. The main tube 95 may be constructed of materials and shape similar to that described above with respect to main tube 5. The main tube 95 is preferably 4 inches in diameter, but may have a different diameter. The main tube 95 includes a viewing portion 100, which is similar to viewing portion 10 described previously, at a first end 96 and a cut out portion 105, which is similar to cut out portion 15 described previously, at the second end 97. An edge of the cut out portion 105 may or may not serve as a primary length indicator, for example, as described previously.

Unlike the fish measuring device 1, which includes a cap 30 to enclose one end of the main tube 5, the fish measuring device 80 preferably includes an integral cap, or wall 110 for enclosing, or substantially enclosing, the first end 95 of the main tube 95.

Preferably, a primary length indicator is provided by a first set of measuring marks 115, which may be in any units including metric, such as centimeters, or English, such as inches. A secondary length indicator 120 is preferably included on the tray 90 and preferably continues its numbering sequentially after the highest number of the primary length indicator 115 at the second end 97 of the main tube 95. The primary and secondary length indicators 115 and 120 may include a measuring device adhered, embedded, or otherwise secured to the main tube 95 and the tray 90, respectively, or may be printed, inscribed, or otherwise marked on the main tube 95 and the tray 90.

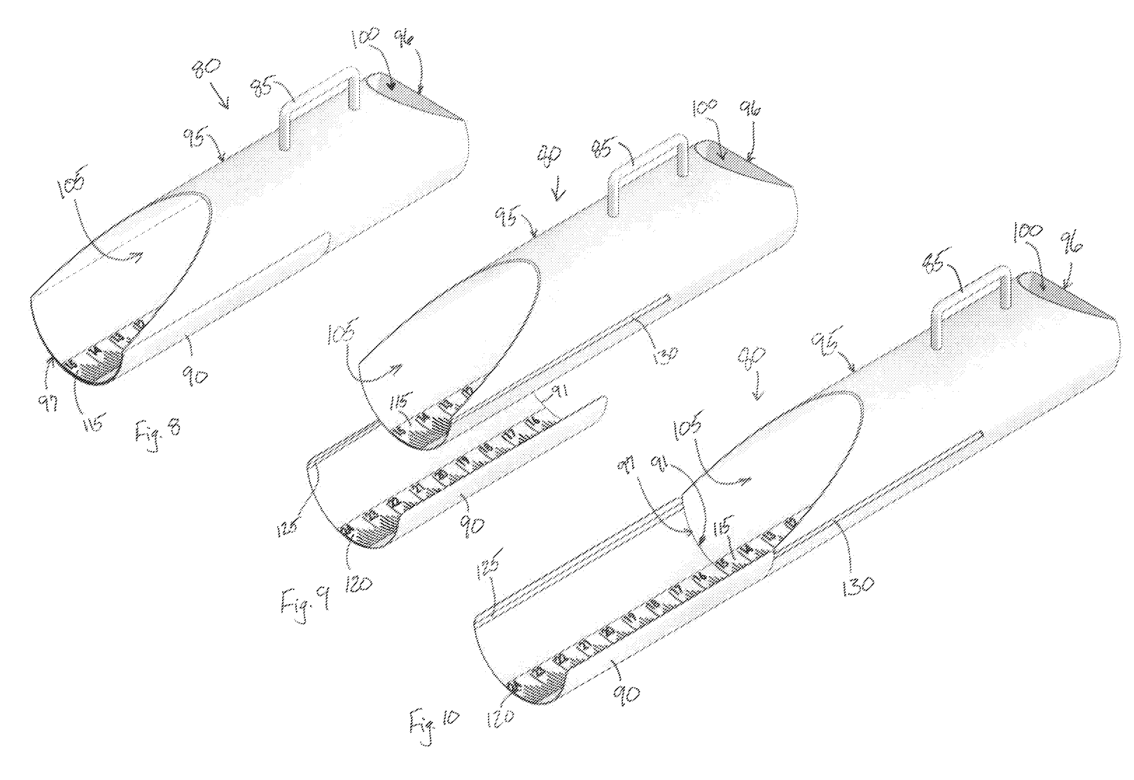

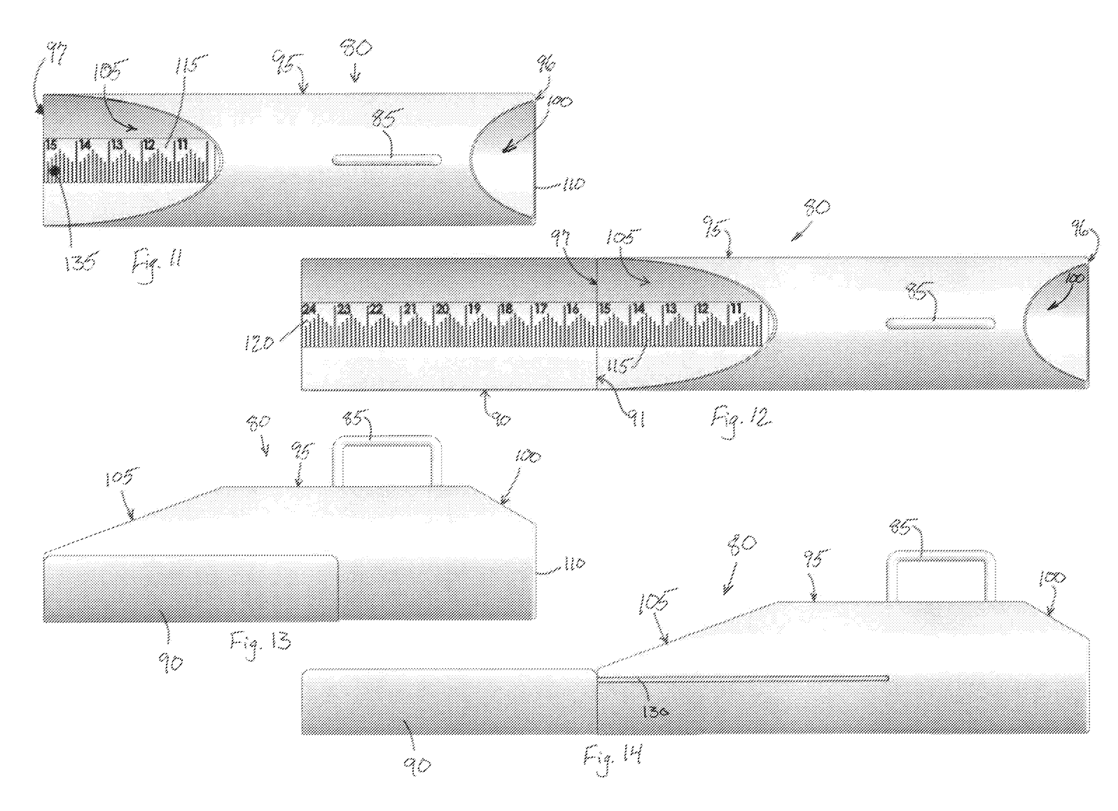

Tray 90 preferably includes two lips 125 that slide into grooves 130 in the main tube 95. To store tray 90, a user slides the tray 90 to the storage position illustrated in FIGS. 8 and 13. To use the tray 90, a user slides the tray 90 to the measuring position illustrated in FIGS. 10 and 12. Alternatively, tray 90 may be separable from the main tube 95, for example, as illustrated in FIG. 9. Tray 90 may be secured to the main tube 95 in the storage position via other mechanisms, such as magnets, hook and loop fasteners, or other suitable devices. Tray 90 may be secured to the main tube 95 in the measuring position by a series of holes and mating posts, for example, a series of holes formed in the rim of the second end 97 of the main tube 95 and a series of mating posts formed in the first end 91 of the tray 90. Other suitable mechanisms or devices may be used to fasten or secure the tray 90 in the measuring position.

Optionally, an aperture 135 (FIG. 11) may be included to hang or otherwise attach a fish measuring device, for example, the fish measuring device 1 or 80, to a scale for weighing a fish placed in the main tube 95. Preferably, the weight of the fish measuring device may be provided on the main tube so an angler can quickly determine the weight of the fish without needing to separately weigh the fish measuring device.

It will be obvious to those having skill in the art that many changes may be made to the details of the above-described embodiments without departing from the underlying principles of the invention. The scope of the present invention should, therefore, be determined only by the following claims.

1. A fish measuring device comprising:
a main tube, wherein the main tube includes a cut out portion proximate a second end of the main tube and an enclosed tubular portion between the second end of the main tube and a first end of the main tube;
an end wall proximate the first end of the main tube;
and a primary length indicator located a known distance from the end wall.

2. A fish measuring device according to claim 1, further comprising a viewing portion proximate the first end of the main tube.

3. A fish measuring device according to claim 1, further comprising a secondary length indicator.

4. A fish measuring device according to claim 1, further comprising an attachment structure.

5. A fish measuring device according to claim 1, wherein the main tube is made of a transparent material.

6. A fish measuring device according to claim 3, wherein the primary length indicator includes a plurality of markings on the inside of the main tube.

7. A fish measuring device according to claim 1, further comprising a cap secured to the first end of the main tube.

8. A fish measuring device according to claim 1, further comprising a tray moveable between a storage position and a measuring position.

9. A fish measuring device according to claim 8, further comprising:
a primary length indicator borne on the main tube; and
a secondary length indicator borne on the tray.

10. A method for measuring the length of a fish comprising:
placing a fish nose first into a fish measuring device main tube so that the fish's nose touches an end wall and at least a portion of the main tube encloses the fish;
visually verifying that the fish's nose touches the end wall;
reaching through a cut out portion of the main tube and squeezing together a first fin and a second fin of the fish's tail to obtain a fish end position;
comparing the fish end position to a primary length indicator;
determining whether the fish meets a minimum length based on the comparing step; and
determining whether the fish may be kept based on the previous determining step.

11. A fish measuring device comprising:
means for retaining and calming a fish; and
measuring means for determining a length of a fish.
